(19) United States
(12) Patent Application Publication
(10) Pub. No.: US 2024/0202313 A1
(43) Pub. Date: Jun. 20, 2024

(54) IMPLEMENTING SECURE MAINTENANCE INCLUDING SECURE DEBUG

(71) Applicant: Cisco Technology, Inc., San Jose, CA (US)

(72) Inventors: Chandan Singh, Bangalore (IN); Ofer Licht, Scotts Valley, CA (US); Chirag Shroff, Cary, NC (US); Srinivas Kothapally, Cary, NC (US)

(21) Appl. No.: 18/084,196

(22) Filed: Dec. 19, 2022

(51) Int. Cl. G06F 21/52; G06F 21/57

(52) U.S. Cl. CPC G06F 21/52; G06F 21/575; G06F 2221/033

(57) ABSTRACT

Techniques and architecture are described to control a debug port access employing the debug image signed offline by a challenge/response mechanism, where the signed image itself is tied to an ECID of a chip together with debug lifecycle information coming from fuses and a hash of a loader being debugged. All these inputs form a nonce (the debug image) that ties the debug image to the hardware being debugged and is restricted to the current debug lifecycle. The cryptographically signed debug image is authenticated by a boot image (or the chip) with a public key in the debug image. The debug image may be expanded to secure maintenance using a secure maintenance blob or “firmware maintenance certificate or nonce.” The secure maintenance blob also includes a natural attribute list of low-level features to be enabled upon verification of the secure maintenance blob.

### TECHNICAL FIELD

The present disclosure relates generally to secure maintenance using a secure maintenance character large object (blob) in a chip of an electronic device, and more particularly, to secure debug using a secure blob in non-volatile memory of the chip in the electronic device.

### BACKGROUND

There are various implementations adopted by system-on-chip (SoC) manufacturers to limit access to joint test action group (JTAG) ports so that attackers are not able to abuse the JTAG interface. Generally, such processes are categorized as secure debug, where the secure debug is enabled in a restrictive and controlled manner to avoid the attacks. Often it is necessary to access debug during early boot of the SoC when the system resources are constrained, e.g., firmware is executing from read only memory (ROM) and has limited resources in terms of static random access memory (SRAM), random number generators, time keeping resources, etc. Thus, it can be difficult to provide adequate protection against attackers that wish to access the JTAG or debug port during a boot process given such limited resources.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIGS. 1A and 1B schematically illustrate an example arrangement that includes an electronic device and a process within the arrangement that provides a secure debug image, in accordance with the techniques and architecture described herein.

FIG. 2 schematically illustrates an example workflow creating a secure debug image or blob, in accordance with the techniques and architecture described herein.

FIG. 3 illustrates a flow diagram of an example method for performing a secure maintenance using a secure maintenance image or blob, in accordance with the techniques and architecture described herein.

FIG. 4 is a computer architecture diagram showing an example computer hardware architecture for implementing a device that can be utilized to implement aspects of the various technologies presented herein.

### DESCRIPTION OF EXAMPLE EMBODIMENTS

### Overview

The present disclosure provides techniques and architecture for providing secure debug or secure joint test action group (JTAG), which is mainly implemented by sharing a challenge (a unique ID as a function of an exclusive chip identification (ECID), a debug lifecycle fuse value, and a hash of a next stage boot image on non-volatile memory of a chip, e.g., flash memory).

The techniques and architecture generally provide a secure debug using a debug character large object (blob) (e.g., certificate or nonce) that can also be expanded to secure maintenance using a maintenance blob or “firmware maintenance certificate or nonce.” The process may utilize mechanisms to create a unique ID to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/SWD or other mechanisms), and fuse programming (in general) and for lifecycle fuses specifically (through JTAG or other mechanisms).

As an example, a method may include creating, by a control entity, a secure maintenance challenge comprising a unique identification (ID) of a chip of an electronic device. The method may also include providing, to a signing entity by the control entity, the secure maintenance challenge. The method may additionally include signing, by the signing entity, the secure maintenance challenge to provide a response comprising the secure maintenance challenge and a signature. The method may further include providing, to the control entity by the signing entity, the response. The method may additionally include based at least in part on the response, creating, by the control entity, a secure maintenance image comprising the secure maintenance challenge and the signature. The method may also include providing, by the control entity, the secure maintenance image to a read-only memory (ROM) of the chip. The method may further include during a boot process of the electronic device, authenticating, by the chip, the secure maintenance image. The method may also include based at least in part on authenticating the secure maintenance image, enabling, by the chip, a feature of the chip.

### Example Embodiments

As previously noted, the present disclosure provides techniques and architecture for providing secure debug or secure joint test action group (JTAG), which is mainly implemented by sharing a challenge (a unique ID as a function of an exclusive chip identification (ECID), a debug lifecycle fuse value, and a hash of a next (second) stage boot image on non-volatile memory of a chip, e.g., flash memory). The techniques and architecture generally provide a secure debug using a debug character large object (blob) (e.g., certificate or nonce) that can also be expanded to secure maintenance using a maintenance blob or “firmware maintenance certificate or nonce.” The process may utilize mechanisms to create a unique ID to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/SWD or other mechanisms), and fuse programming (in general) and for lifecycle fuses specifically (through JTAG or other mechanisms).

In particular, the techniques and architecture provide for a simple mechanism to control the debug port access employing a debug blob signed offline by a challenge/response mechanism, where the signed blob itself is tied to the ECID of the chip together with debug lifecycle information coming from fuses and the hash of an image on non-volatile memory of the chip being debugged (which in examples is a next (second) level boot image stored in flash memory). All these inputs together (ECID plus debug lifecycle fuses plus hash of the image) form a nonce (the debug blob) that ties the debug blob to the hardware being debugged and is restricted to the current debug lifecycle. The cryptographically signed debug blob is authenticated by firmware running from ROM, e.g., BootROM (or the chip) with a public key in the debug blob. The public key is authenticated by having been signed with a product root key and the root key hash is burned in fuses that form a root of trust for the authentication process as in the SecureBoot flow.

Thus, the authentication portion for access to the debug port of a chip is separated from the signature portion. The signature helps ensure that the debug port is only open when authentication is true.

In particular, the challenge/response flow is handled offline. A challenge is created based on a unique ID of the chip along with debug flags related to debug fuses, and a header that includes various pieces of information. In configurations, the header may be 32 bytes. The challenge may then be cryptographically signed by a signing entity, e.g., a signing server (only an authorized user may sign the challenge). The challenge and signature may be added as part of a response as a type length value (TLV) blob (debug blog or debug image). This debug blob may then be programmed on the non-volatile memory, e.g., flash memory at a fixed offset from a loader of the boot flash memory. The firmware running from the ROM, e.g., BootROM, while booting, checks and cryptographically validates the debug blob if present and validates the unique ID based on the ECID, the debug flags set in the debug blob, and the hash of the next level boot image. The boot flash memory may then enable respective debugs, e.g., allow access to the debug port. Generally, as is known, the boot process occurs during a full reset of the electronic device or when a power cycle occurs. Examples of the electronic device include, but are not limited to, routers, switches, computers, etc.

Generally, there is an executable image, e.g., a boot image in the boot flash memory of the electronic device, which is the software that is intended to be debugged. The unique ID is created with information, e.g., the ECID of a chip, during the manufacture of the chip and/or the electronic device. The ECID may pertain to a chip that includes a system on chip (SoC). This unique ID may then be signed by a signing entity. The result of the signature is an audit trail and the debug blob (bitstream). The ECID, along with the hash of the image to be debugged and the debug lifecycles, e.g., the debug lifecycle fuse value, are all validated. If validated, then the JTAG port or debug port may be opened for debugging. If any of the three are not validated, then the booting process continues without opening the JTAG port, e.g., the debug port.

Generally, the lifecycle fuses are active for a limited number of times that the debug blob may be utilized. Generally, there are only so many fuses in the lifecycle set. When the debug blob or unique ID was signed, the current state of those lifecycle fuses was taken into account for the debug lifecycle fuse value. Thus, if the lifecycle fuses are changed (which is irrevocable), then any debug blobs that were generated for different lifecycle fuse values will no longer work. The possibility of debug/maintenance can be enabled/disabled a fixed number of times based on the number of pairs of unlock/lock fuses in the lifecycle set of fuses.

As previously noted, the debug blob may be expanded to secure maintenance using a secure maintenance blob or firmware maintenance certificate or nonce. The blob may be created in the manner as previously described including creating a unique ID that is signed but also includes an attribute list of low-level features that may be enabled upon verification of the maintenance blob. The secure maintenance using a secure maintenance blob or “firmware maintenance certificate or nonce” may utilize mechanisms to create a unique ID to be signed as described herein but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/SWD or other mechanisms), and fuse programming (in general) and for lifecycle fuses specifically (through JTAG or other mechanisms).

Thus, as previously noted, in configurations a method may include creating, by a control entity, a secure maintenance challenge comprising a unique identification (ID) of a chip of an electronic device. The method may also include providing, to a signing entity by the control entity, the secure maintenance challenge. The method may additionally include signing, by the signing entity, the secure maintenance challenge to provide a response comprising the secure maintenance challenge and a signature. The method may further include providing, to the control entity by the signing entity, the response. The method may additionally include based at least in part on the response, creating, by the control entity, a secure maintenance image comprising the secure maintenance challenge and the signature. The method may also include providing, by the control entity, the secure maintenance image to a non-volatile memory of the chip. The method may further include during a boot process of the electronic device, authenticating, by the chip, the secure maintenance image. The method may also include based at least in part on authenticating the secure maintenance image, enabling, by the chip, a feature of the chip.

In configurations, the chip comprises a system-on-chip (SoC) and enabling the feature of the chip comprises enabling debugging of one or more processors of the SoC.

In configurations, enabling the feature of the chip comprises programming of fuses. In some configurations, programming of fuses comprises programming of lifecycle fuses.

In configurations, enabling the feature of the chip comprises enabling access to maintenance ports of the chip. In some configurations, enabling access to maintenance ports of the chip comprises enabling access to maintenance ports of the chip for debugging of a next stage boot image located in the non-volatile memory.

In configurations, authenticating, by the chip, the secure maintenance image comprises authenticating an exclusive chip ID (ECID) of the chip, authenticating a hash of the next stage boot image, and verifying that debug lifecycles within the secure maintenance image have not been met.

In configurations, the method further includes based at least in part on a delay within the secure maintenance image, delaying loading, by firmware in the ROM, a boot code, e.g., BootROM.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

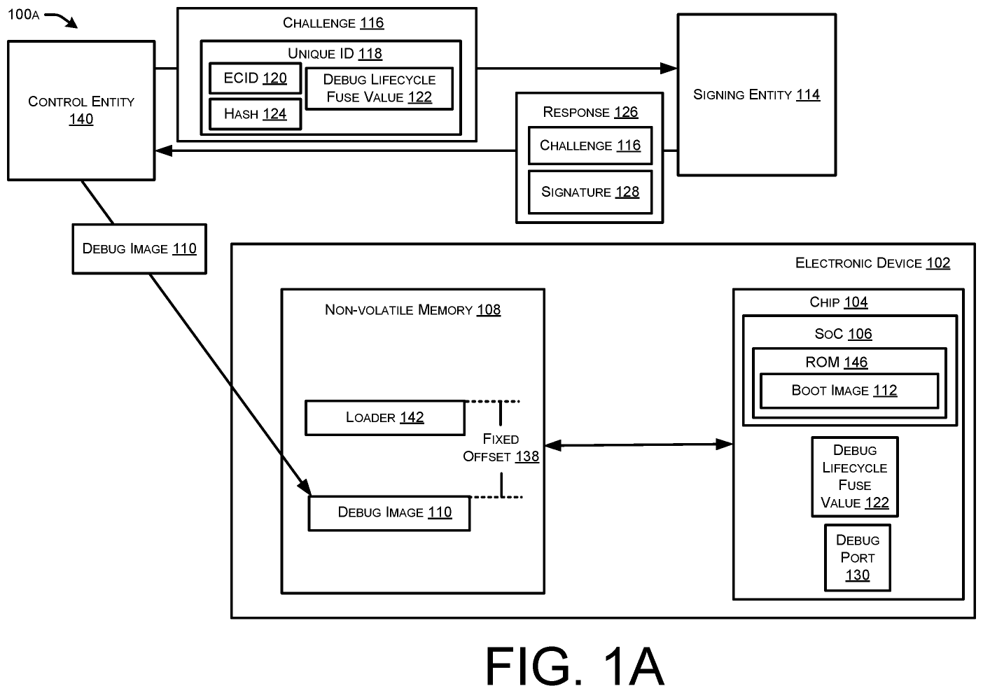

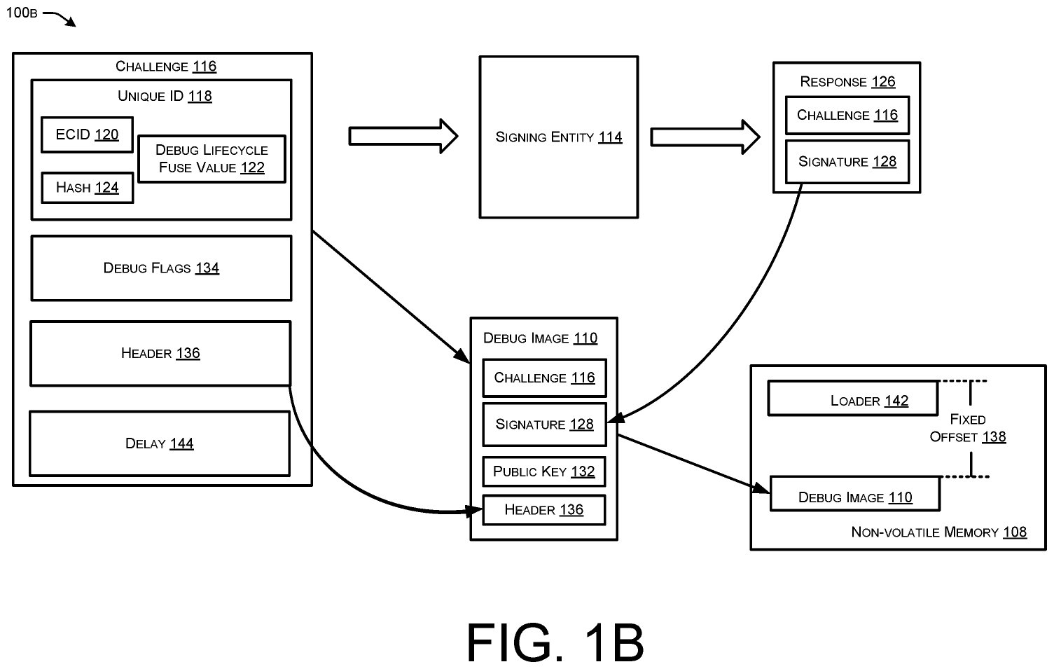

FIG. 1A schematically illustrates an example arrangement 100a that includes an electronic device 102. The electronic device 102 includes a chip 104 that includes a system on chip (SoC) 106. A non-volatile memory 108, e.g., flash memory, is included on the electronic device 102 and is communicatively coupled to the chip 104. In configurations, the non-volatile memory 108 may be in the form of flash memory. The non-volatile memory 108 includes a debug or maintenance image 110, and the SoC 106 includes ROM 146 that includes a boot image 112 (e.g., BootROM) as described further herein. The arrangement 100a further includes a signing entity 114, e.g., a signing server.

In configurations, a challenge 116 is shared, e.g., created, by a control entity 140. The challenge 116 includes a unique ID 118. The unique ID 118 is a function of an exclusive chip identification (ECID) 120 of the chip 104, a debug lifecycle fuse value 122 on the chip 104 for debug fuses, and a hash 124 of a loader 142 on the non-volatile memory 108, e.g., flash memory. The challenge 116 is shared over a secured network channel to the signing entity 114. The signing entity 114 signs the challenge 116 and sends back a response 126 to the control entity 140 that includes the challenge 116 and a signature 128. This process is performed offline without the electronic device 102 and chip 104 being involved. The response 126 with the signature 128 is used to create (offline) the debug image 110 for on-chip verification and opening of the JTAG port or debug port 130 of the chip 104 (and/or electronic device 102). The debug image 110 is programmed on the non-volatile memory 108, e.g., flash memory, at a known, fixed location.

In configurations, the response 126 may be programmed on the non-volatile memory 108 (e.g., boot flash memory) as debug image 110 by the control entity 140 at a fixed offset 138 from a loader 142 of the non-volatile memory 108. The firmware in ROM 146, which is boot image 112 (e.g., BootROM), while booting, checks and cryptographically validates the debug image 110 and validates the unique ID 118 based on the ECID 120, the debug lifecycle fuse value 122 set in the debug image 110, and the hash 124 of the next level loader 142. The boot image 112, e.g., BootROM, (or chip 104) may then enable respective debugs, e.g., allow access to the debug port 130. Generally, as is known, the boot process occurs during a full reset of the electronic device 102 or when a power cycle occurs.

FIG. 1B schematically illustrates a process 100b within the arrangement 100a that provides the secure debug image 110. The debug image 110 is generally in the form of a debug character large object (blob) (e.g., certificate or nonce) that can also be expanded to secure maintenance that uses a secure maintenance blob or “firmware maintenance certificate or nonce.” The process 100b may utilize mechanisms to create the unique ID 118 to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/serial wire debug (SWD) or other mechanisms), and fuse programming (in general) and for lifecycle fuses specifically (through JTAG or other mechanisms).

In particular, the process 100b provides for a simple mechanism to control the debug port 130 access employing the debug blob (debug image 110) signed offline by a challenge/response mechanism, where the signed blob itself is tied to the ECID 120 of the chip 104 together with debug lifecycle fuse value 122 coming from fuses and the hash 124 of the next level loader 142 on the non-volatile memory 108 being debugged (which in examples is a next (second) level boot image stored in flash memory, e.g., non-volatile memory 108). All these inputs together (ECID 120 plus debug lifecycle fuse value 122 plus hash 124 of the boot image 112) form a nonce (the debug image 110) that ties the debug image 110 to the hardware (e.g., chip 104 and/or electronic device 102) being debugged and is restricted to the current debug lifecycle. During booting, the cryptographically signed debug image 110 is authenticated by the boot image 112, e.g., BootROM, (or the chip 104) with a public key 132 in the debug image 110. The public key 132 is authenticated by having been signed with a product root key and the root key hash is burned in fuses that form a root of trust for the authentication process as in the Secure Boot flow.

Thus, the authentication portion for access to the debug port 130 of the chip 104 and/or electronic device 102 is separated from the signature portion, e.g., the creation of the debug image 110 via the response 126 and the signature 128. The signature 128 helps ensure that the debug port 130 is only open when authentication is true.

In particular, the challenge/response flow of the process 100b is handled offline. The challenge 116 is created by the control entity 140 based on the unique ID 118 with debug flags 134, and a header 136 that includes various pieces of information related to the challenge 116. In configurations, the header 136 may be 32 bytes. The challenge 116 may then be cryptographically signed by the signing entity 114, e.g., a signing server (only an authorized user may sign the challenge). The challenge 116 and the signature 128 may be added as part of the response 126 as a type length value (TLV) blob (debug blog or debug image 110). The debug image 110 may then be programmed on the non-volatile memory 108 (e.g., boot flash memory) by the control entity 140 at a fixed offset 138 from a loader 142 of the non-volatile memory 108. The boot image 112, e.g., BootROM, while booting, checks and cryptographically validates the debug image 110 and validates the unique ID 118 based on the ECID 120, the debug lifecycle fuse value 122 set in the debug image 110, and the hash 124 of the next level loader 142. The boot image 142, e.g., BootROM, may then enable respective debugs, e.g., allow access to the debug port 130. Generally, as is known, the boot process occurs during a full reset of the electronic device 102 or when a power cycle occurs. The electronic device 102 may be any electronic device with an embedded microprocessor or programmable micro-controller and some form of debug bus (or other maintenance functions). Examples of the electronic device 102 include, but are not limited to, routers, switches, computers. Internet of Things (IOT) devices, medical devices, tools, appliances, etc.

Generally, there is an executable image, e.g., the boot image 112 in the ROM 146 of SoC 106 on chip 104, which is the software that is intended to be debugged. The unique ID 118 is created with information, e.g., the ECID 120 of the chip 104, during the manufacture of the chip 104 and/or the electronic device 102. The ECID 120 may pertain to a chip that includes a system on chip (SoC). This unique ID 118 may then be signed by the signing entity 114. The result of the signature is an audit trail and the debug image 110 (bitstream). The ECID 120, along with the hash 124 of the image to be debugged and the debug lifecycle fuse value 122 are all validated. If validated, then the JTAG port or debug port 130 may be opened for debugging. If any of the three are not validated, then the booting process continues without opening the JTAG port, e.g., the debug port 130.

BootROM, e.g., the boot image 112, is on-chip boot code, which is root-of-trust and responsible for validating and loading a next level of boot code from external media. At times it may be necessary to debug the first boot code getting loaded by BootROM. To enable this, in configurations the challenge 116 present in debug image 110 includes a delay field 144 to instruct/request BootROM to wait before loading the next boot code. This enables a user to connect and keep JTAG ready to start debugging the boot code early in the boot process.

Generally, the lifecycle fuses for the debug lifecycle fuse value 122 are active for a limited number of times that the debug blob may be utilized. Generally, there are only so many fuses in the lifecycle set. When the debug blob or unique ID was signed, the current state of those lifecycle fuses was taken into account. Thus, if the lifecycle fuses are changed (which is irrevocable), then any debug blobs that were generated for different lifecycle fuse values will no longer work. The possibility of debug/maintenance can be enabled/disabled a fixed number of times based on the number of pairs of unlock/lock fuses in the lifecycle set of fuses.

In particular, the techniques and architecture described herein are centered around raw silicon of the chip 104. With typical SoC silicon, during a first instruction boot, only about 256 KB of ROM and SRAM is available. The techniques and architecture described herein are optimized and focused on enabling very low-level debugging for SoCs on chips. The ROM implementation does not have a notion of time as the SoC itself does not have a real time clock (RTC).

However, fuses are used herein to define the debug lifecycle fuse value 122 to mark a particular debug life cycle state, which ties the debug image 110 generated to a particular debug cycle. For example, once the electronic device 102 comes to a factory or lab for return materials authorization (RMA), the set of fuses are blown to enable the debug. Same sets of fuses are used as input (together with SoC ECID 120 and the hash 124 of the next stage image in the non-volatile memory 108, e.g., flash memory such as serial peripheral interface (SPI) flash memory) to the challenge, which is then signed offline to get debug image signature 128. Logic is to include this information during authentication to make sure the debug image 110 is only valid if the fuse states encoded in the debug image 110 matches with what is blown in hardware together with the ECID 120 and the hash 124 of the next stage image in non-volatile memory 108, e.g., flash memory such as SPI flash memory. Once this cycle is done, fuses are blown again to lock the debug and hence JTAG lines are disconnected internally within the silicon of the chip 104.

Once the last debug cycle is consumed, the last state is locked to avoid any further debug or exploitation. The number of unlock/lock debug cycles is determined by the availability of fuse bits in hardware. Table 1 below illustrates an example set of lock/unlock debug lifecycle states that supports 4 debug cycles (number of lock/unlock pairs can be increased). Thus, after 4 debug cycles, the last state is “locked,” i.e., debug is not possible.

TABLE 1

| | | | | | | | | Debug |
|---|---|---|---|---|---|---|---|---|
| | Debug lifecycle fuse bits | | | | | | | possible |
| Debug | | | | un- | | un- | Final | with |
| Cycle | lock0 | unlock0 | lock1 | lock1 | lock2 | lock2 | lock | Auth? |
| 1 | 0 | 0 | 0 | 0 | 0 | 0 | 0 | yes |
| | 1 | 0 | 0 | 0 | 0 | 0 | 0 | no |
| 2 | 1 | 1 | 0 | 0 | 0 | 0 | 0 | yes |
| | 1 | 1 | 1 | 0 | 0 | 0 | 0 | no |
| 3 | 1 | 1 | 1 | 1 | 0 | 0 | 0 | yes |
| | 1 | 1 | 1 | 1 | 1 | 0 | 0 | no |
| 4 | 1 | 1 | 1 | 1 | 1 | 1 | 0 | yes |
| | 1 | 1 | 1 | 1 | 1 | 1 | 1 | no |

As previously noted, the debug image 110 may be expanded for secure maintenance using a secure maintenance image or firmware maintenance certificate or nonce. The secure maintenance image may be created in the manner as previously described including creating a unique ID that is signed but also includes an attribute list of low-level features that may be enabled upon verification of the maintenance blob. The secure maintenance using a maintenance image or “firmware maintenance certificate or nonce” may utilize mechanisms to create a unique ID to be signed as described herein but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/SWD or other mechanisms), and fuse programming (in general) and for lifecycle fuses specifically (through JTAG or other mechanisms).

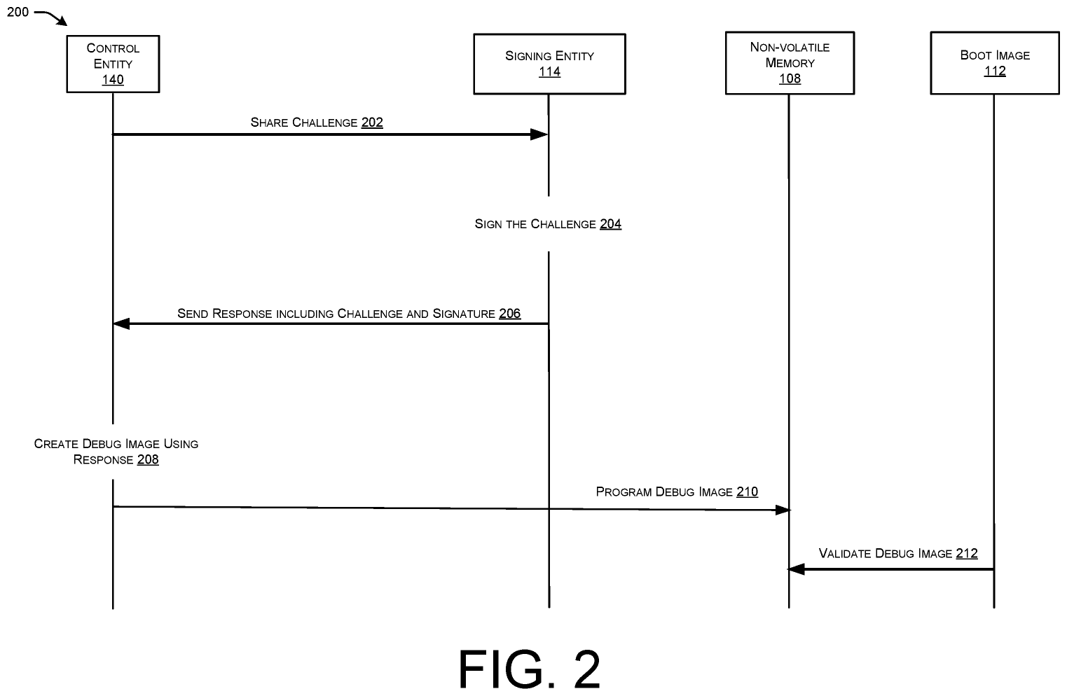

FIG. 2 schematically illustrates an example workflow 200 for creating a secure debug image or blob, e.g., secure debug image 110. At 202, a challenge, e.g., challenge 116, is shared, e.g., created, by a control entity, e.g., control entity 140, with a signing entity, e.g., signing entity 114. In configurations, the challenge 116 includes a unique ID 118. The unique ID 118 is a function of an exclusive chip identification (ECID) 120 of the chip 104, a debug lifecycle fuse value 122 for debug fuses, and a hash 124 of a next (second) stage of the boot image 112 on the non-volatile memory 108, e.g., flash memory. The challenge 116 is shared over a secure network channel to the signing entity 114.

At 204, the signing entity 114 signs the challenge 116. At 206, the signing entity 114 sends back a response, e.g., response 126, to the control entity 140. In configurations, the response 126 includes the challenge 116 and a signature 128 over a secure network channel for on-chip verification and opening of the JTAG port or debug port 130 of the chip 104 (and/or electronic device 102) that is used to form the debug image 110.

At 208, the response 126 is used by the control entity 140 to create a debug image, e.g., debug image 110. In configurations, the debug image 110 is in the form of a debug character large object (blob) (e.g., certificate or nonce) that can also be expanded to secure maintenance using a secure maintenance blob or “firmware maintenance certificate or nonce.” The control entity 140 may utilize mechanisms to create the unique ID 118 to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/serial wire debug (SWD) or other mechanisms), and fuse programming (in general) and for lifecycle fuses specifically (through JTAG or other mechanisms).

At 210, the control entity 140 programs the debug image 110 on the non-volatile memory 108 (e.g., boot flash memory) as debug image 110 at a fixed offset 138 from a loader 142 of the non-volatile memory 108. At 212, the boot image 112, e.g., BootROM, while booting, checks and cryptographically validates the debug image 110 and validates the unique ID 118 based on the ECID 120, the debug lifecycle fuse value 122 set in the debug image 110, and the hash 124 of the next level loader 142. The boot image 112, e.g., BootROM, may then enable respective debugs, e.g., allow access to the debug port 130. Generally, as is known, the boot process occurs during a full reset of the electronic device 102 or when a power cycle occurs. The workflow 200 provides for a simple mechanism to control the debug port 130 access employing the debug blob (debug image 110) signed offline by a challenge/response mechanism, where the signed blob itself is tied to the ECID 120 of the chip 104 together with debug lifecycle fuse value 122 coming from fuses and the hash 124 of the boot image 112 on the non-volatile memory 108 being debugged (which in examples is a next level boot image stored in flash memory, e.g., non-volatile memory 108). All these inputs together (ECID 120 plus debug lifecycle fuse value 122 plus hash 124 of the boot image 112) form a nonce (the debug image 110) that ties the debug image 110 to the hardware (e.g., chip 104 and/or electronic device 102) being debugged and is restricted to the current debug lifecycle. The cryptographically signed debug image 110 is authenticated by the boot image 112, e.g., BootROM, (or the chip 104) with a public key 132 in the debug image 110. The public key 132 is authenticated by having been signed with a product root key and the root key hash is burned in fuses that form a root of trust for the authentication process as in the SecureBoot flow:

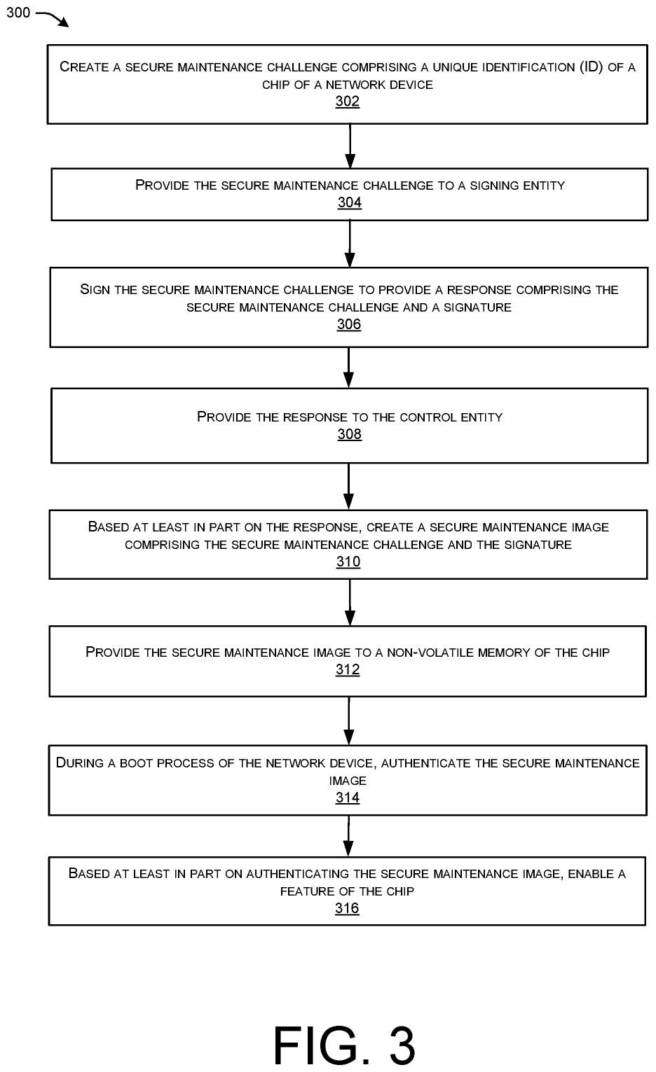

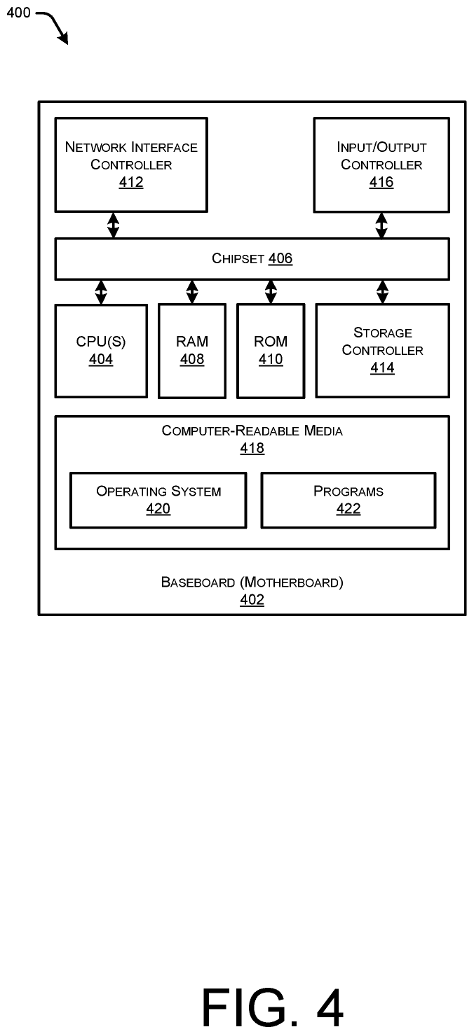

FIG. 3 illustrates a flow diagram of an example method 400 and illustrates aspects of the functions performed at least partly by electronic devices of a network as described with respect to FIGS. 1A, 1B, and 2. The logical operations described herein with respect to FIG. 4 may be implemented (1) as a sequence of computer-implemented acts or program modules running on a computing system, and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 3 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 3 illustrates a flow diagram of an example method 300 for performing a secure maintenance using a secure maintenance image or blob, e.g., secure debug image 110. In some examples, the method 300 may be performed by a system comprising one or more processors and one or more non-transitory computer-readable media storing computer-executable instructions that, when executed by the one or more processors, cause the one or more processors to perform the method 300.

At 302, a secure maintenance challenge comprising a unique identification (ID) of a chip of an electronic device is created by a control entity. For example, challenge 116, may be created by control entity 140. In configurations, the challenge 116 includes a unique ID 118. The unique ID 118 is a function of an exclusive chip identification (ECID) 120 of the chip 104, a debug lifecycle fuse value 122 for debug fuses, and a hash 124 of a next stage of the boot image 112 on the non-volatile memory 108, e.g., flash memory.

At 304, the control entity provides the secure maintenance challenge to a signing entity. For example, challenge 116, may be shared by control entity 140 with a signing entity, e.g., signing entity 114. In configurations, the challenge 116 is shared over a secure network channel to the signing entity 114.

At 306, the signing entity signs the secure maintenance challenge to provide a response comprising the secure maintenance challenge and a signature. For example, the response 126 includes the challenge 116 and a signature 128.

At 308, the signing entity provides the response to the control entity. For example, the response 126 includes the challenge 116 and a signature 128 over JTAG for on-chip verification and opening of the JTAG port or debug port 130 of the chip 104 (and/or electronic device 102) that is used to form the debug image 110.

At 310, based at least in part on the response, the control entity creates a secure maintenance image comprising the secure maintenance challenge and the signature. For example, the control entity 140 creates the debug image 110 in the form of a debug character large object (blob) (e.g., certificate or nonce) that can also be expanded to secure maintenance using a secure maintenance blob or “firmware maintenance certificate or nonce.” The control entity 140 may utilize mechanisms to create the unique ID 118 to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/serial wire debug (SWD) or other mechanisms), and fuse programming (in general) and for lifecycle fuses specifically (through JTAG or other mechanisms).

At 312, the control entity provides the secure maintenance image to a non-volatile memory of the chip. For example, the control entity 140 programs the response 126 on the non-volatile memory 108 (e.g., boot flash memory) as debug image 110 at a fixed offset 138 from a loader 142 of the non-volatile memory 108.

At 314, during a boot process of the electronic device, the chip authenticates the secure maintenance image. For example, the chip 104, during a boot process, checks and cryptographically validates the debug image 110 and validates the unique ID 118 based on the ECID 120, the debug lifecycle fuse value 122 set in the debug image 110, and the hash 124 of the next level loader 142. As previously noted, the process 100b provide a simple mechanism to control the debug port 130 access employing the debug blob (debug image 110) signed offline by a challenge/response mechanism, where the signed blob itself is tied to the ECID 120 of the chip 104 together with debug lifecycle fuse value 122 coming from fuses and the hash 124 of the loader 142 on the non-volatile memory 108 being debugged (which in examples is a next level boot image stored in flash memory, e.g., non-volatile memory 108). All these inputs together (ECID 120 plus debug lifecycle fuse value 122 plus hash 124 of the loader 142) form a nonce (the debug image 110) that ties the debug image 110 to the hardware (e.g., chip 104 and/or electronic device 102) being debugged and is restricted to the current debug lifecycle. The cryptographically signed debug image 110 is authenticated by the boot image 112, e.g., BootROM, (or the chip 104) with a public key 132 in the debug image 110. The public key 132 is authenticated by having been signed with a product root key and the root key hash is burned in fuses that form a root of trust for the authentication process as in the SecureBoot flow.

At 316, based at least in part on authenticating the secure maintenance image, the chip enables a feature of the chip. For example, in configurations, the chip 104 may enable respective debugs, e.g., allow access to the debug port 130. Generally, as is known, the boot process occurs during a full reset of the electronic device 102 or when a power cycle occurs. As previously noted, in configurations where the control entity 140 creates a secure maintenance blob or “firmware maintenance certificate or nonce,” the control entity 140 may utilize mechanisms to create the unique ID 118 to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/serial wire debug (SWD) or other mechanisms), and fuse programming (in general) and for lifecycle fuses specifically (through JTAG or other mechanisms).

Thus, the techniques and architecture described herein provide a simple mechanism to control the debug port 130 access employing the debug blob (debug image 110) signed offline by a challenge/response mechanism, where the signed blob itself is tied to the ECID 120 of the chip 104 together with debug lifecycle fuse value 122 coming from fuses and the hash 124 of the loader 142 on the non-volatile memory 108 being debugged (which in examples is a next level boot image stored in flash memory, e.g., non-volatile memory 108). All these inputs together (ECID 120 plus debug lifecycle fuse value 122 plus hash 124 of the loader 142) form a nonce (the debug image 110) that ties the debug image 110 to the hardware (e.g., chip 104 and/or electronic device 102) being debugged and is restricted to the current debug lifecycle. The cryptographically signed debug image 110 is authenticated by the boot image 142, e.g., BootROM, (or the chip 104) with a public key 132 in the debug image 110. The public key 132 is authenticated by having been signed with a product root key and the root key hash is burned in fuses that form a root of trust for the authentication process as in the SecureBoot flow: The debug image 110 can also be expanded to secure maintenance using a secure maintenance blob or “firmware maintenance certificate or nonce.” The control entity 140 may utilize mechanisms to create the unique ID 118 to be signed but also includes a natural attribute list of low-level features to be enabled upon verification of the maintenance blob. Such features may include, but are not limited to, access to JTAG and other maintenance ports (for various low-level, non-debug chip access functions), various levels of invasive and non-invasive processor debug (through JTAG/serial wire debug (SWD) or other mechanisms), and fuse programming (in general) and for lifecycle fuses specifically (through JTAG or other mechanisms).

FIG. 4 shows an example computer architecture for a computing device 400 capable of executing program components for implementing the functionality described above. In configurations, one or more of the computing devices 400 may be used to implement one or more of the components of FIGS. 1A, 1B, 2, and 3. The computer architecture shown in FIG. 4 illustrates a conventional server computer, router, switch, workstation, desktop computer, laptop, tablet, network appliance, e-reader, smartphone, or other computing device, and can be utilized to execute any of the software components presented herein. The computing device 400 may, in some examples, correspond to a physical device or resources described herein.

The computing device 400 includes a baseboard 402, or “motherboard,” which is a printed circuit board to which a multitude of components or devices can be connected by way of a system bus or other electrical communication paths. In one illustrative configuration, one or more central processing units (“CPUs”) 404 operate in conjunction with a chipset 406. The CPUs 404 can be standard programmable processors that perform arithmetic and logical operations necessary for the operation of the computing device 400.

The CPUs 404 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 406 provides an interface between the CPUs 404 and the remainder of the components and devices on the baseboard 402. The chipset 406 can provide an interface to a RAM 408, used as the main memory in the computing device 400. The chipset 406 can further provide an interface to a computer-readable storage medium such as a read-only memory (“ROM”) 410 or non-volatile RAM (“NVRAM”) for storing basic routines that help to startup the computing device 400 and to transfer information between the various components and devices. The ROM 410 or NVRAM can also store other software components necessary for the operation of the computing device 400 in accordance with the configurations described herein.

The computing device 400 can operate in a networked environment using logical connections to remote computing devices and computer systems through a network. The chipset 406 can include functionality for providing network connectivity through a NIC 412, such as a gigabit Ethernet adapter. In configurations, the NIC 412 can be a smart NIC (based on data processing units (DPUs)) that can be plugged into data center servers to provide networking capability. The NIC 412 is capable of connecting the computing device 400 to other computing devices over networks. It should be appreciated that multiple NICs 412 can be present in the computing device 400, connecting the computer to other types of networks and remote computer systems.

The computing device 400 can include a storage device 418 that provides non-volatile storage for the computer. The storage device 418 can store an operating system 420, programs 422, and data, which have been described in greater detail herein. The storage device 418 can be connected to the computing device 400 through a storage controller 414 connected to the chipset 406. The storage device 418 can consist of one or more physical storage units. The storage controller 414 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 400 can store data on the storage device 418 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 418 is characterized as primary or secondary storage, and the like.

For example, the computing device 400 can store information to the storage device 418 by issuing instructions through the storage controller 414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 can further read information from the storage device 418 by detecting the physical states or characteristics of one or more particular locations within the physical storage units.

In addition to the mass storage device 418 described above, the computing device 400 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 400. In some examples, the operations performed by the cloud network, and or any components included therein, may be supported by one or more devices similar to computing device 400. Stated otherwise, some or all of the operations described herein may be performed by one or more computing devices 400 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 418 can store an operating system 420 utilized to control the operation of the computing device 400. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 418 can store other system or application programs and data utilized by the computing device 400).

In one embodiment, the storage device 418 or other computer-readable storage media is encoded with computer-executable instructions which, when loaded into the computing device 400, transform the computer from a general-purpose computing system into a special-purpose computer capable of implementing the embodiments described herein. These computer-executable instructions transform the computing device 400 by specifying how the CPUs 404 transition between states, as described above. According to one embodiment, the computing device 400 has access to computer-readable storage media storing computer-executable instructions which, when executed by the computing device 400, perform the various processes described above with regard to FIGS. 1A, 1B, 2, and 3. The computing device 400 can also include computer-readable storage media having instructions stored thereupon for performing any of the other computer-implemented operations described herein.

The computing device 400 can also include one or more input/output controllers 416 for receiving and processing input from a number of input devices, such as a keyboard, a mouse, a touchpad, a touch screen, an electronic stylus, or other type of input device. Similarly, an input/output controller 416 can provide output to a display, such as a computer monitor, a flat-panel display, a digital projector, a printer, or other type of output device. It will be appreciated that the computing device 400 might not include all of the components shown in FIG. 4, can include other components that are not explicitly shown in FIG. 4, or might utilize an architecture completely different than that shown in FIG. 4.

The computing device 400 may support a virtualization layer, such as one or more virtual resources executing on the computing device 400. In some examples, the virtualization layer may be supported by a hypervisor that provides one or more virtual machines running on the computing device 400 to perform functions described herein. The virtualization layer may generally support a virtual resource that performs at least portions of the techniques described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
creating, by a control entity, a secure maintenance challenge comprising a unique identification (ID) of a chip of an electronic device;
providing, to a signing entity by the control entity, the secure maintenance challenge;
signing, by the signing entity, the secure maintenance challenge to provide a response comprising the secure maintenance challenge and a signature;
providing, to the control entity by the signing entity, the response;
based at least in part on the response, creating, by the control entity, a secure maintenance image comprising the secure maintenance challenge and the signature;
providing, by the control entity, the secure maintenance image to a non-volatile memory of the chip;
during a boot process of the electronic device, authenticating, by a boot image, the secure maintenance image; and
based at least in part on authenticating the secure maintenance image, enabling, by the chip, a feature of the chip.

2. The method of claim 1, wherein the chip comprises a system-on-chip (SoC) and enabling the feature of the chip comprises:
enabling debugging of one or more processors of the SoC.

3. The method of claim 1, wherein enabling the feature of the chip comprises:
programming of fuses.

4. The method of claim 3, wherein programming of fuses comprises:
programming of lifecycle fuses.

5. The method of claim 1, wherein enabling the feature of the chip comprises:
enabling access to maintenance ports of the chip.

6. The method of claim 5, wherein enabling access to maintenance ports of the chip comprises:
enabling access to maintenance ports of the chip for debugging of a next stage boot image located on the non-volatile memory.

7. The method of claim 6, wherein authenticating, by the boot image, the secure maintenance image comprises:
authenticating an exclusive chip ID (ECID) of the chip;
authenticating a hash of a loader; and
authenticating debug lifecycles within the secure maintenance image.

8. The method of claim 1, further comprising:
based at least in part on a delay within the secure maintenance image, delaying loading, by the firmware executing from read-only memory (ROM) on the chip, a boot code.

9. A system comprising:
one or more processors; and
one or more non-transitory computer-readable media storing computer-executable instructions that, when executed by the one or more processors, cause the one or more processors to perform actions comprising:
creating, by a control entity, a secure maintenance challenge comprising a unique identification (ID) of a chip of an electronic device;
providing, to a signing entity by the control entity, the secure maintenance challenge:
signing, by the signing entity, the secure maintenance challenge to provide a response comprising the secure maintenance challenge and a signature;
providing, to the control entity by the signing entity, the response:
based at least in part on the response, creating, by the control entity, a secure maintenance image comprising the secure maintenance challenge and the signature;
providing, by the control entity, the secure maintenance image to a non-volatile memory of the chip;
during a boot process of the electronic device, authenticating, by a boot image, the secure maintenance image; and
based at least in part on authenticating the secure maintenance image, enabling, by the chip, a feature of the chip.

10. The system of claim 9, wherein the chip comprises a system-on-chip (SoC) and enabling the feature of the chip comprises:
enabling debugging of one or more processors of the SoC.

11. The system of claim 9, wherein enabling the feature of the chip comprises:
programming of fuses.

12. The system of claim 11, wherein programming of fuses comprises:
programming of lifecycle fuses.

13. The system of claim 9, wherein enabling the feature of the chip comprises:
enabling access to maintenance ports of the chip.

14. The system of claim 13, wherein enabling access to maintenance ports of the chip comprises:
enabling access to maintenance ports of the chip for debugging of a next stage boot image located on the non-volatile memory.

15. The system of claim 14, wherein authenticating, by the boot image, the secure maintenance image comprises:
authenticating an exclusive chip ID (ECID) of the chip;
authenticating a hash of a loader; and
authenticating debug lifecycles within the secure maintenance image.

16. The system of claim 9, wherein the actions further comprise:
based at least in part on a delay within the secure maintenance image, delaying loading, by the firmware executing from read-only memory (ROM) on the chip, a boot code.

17. One or more non-transitory computer-readable media storing computer-executable instructions that, when executed by one or more processors, cause the one or more processors to perform actions comprising:
creating, by a control entity, a secure maintenance challenge comprising a unique identification (ID) of a chip of an electronic device;
providing, to a signing entity by the control entity, the secure maintenance challenge;
signing, by the signing entity, the secure maintenance challenge to provide a response comprising the secure maintenance challenge and a signature;
providing, to the control entity by the signing entity, the response;
based at least in part on the response, creating, by the control entity, a secure maintenance image comprising the secure maintenance challenge and the signature;
providing, by the control entity, the secure maintenance image to a non-volatile memory of the chip;
during a boot process of the electronic device, authenticating, by a boot image, the secure maintenance image; and
based at least in part on authenticating the secure maintenance image, enabling, by the chip, a feature of the chip.

18. The one or more non-transitory computer-readable media of claim 17, wherein enabling the feature of the chip comprises:
enabling access to maintenance ports of the chip.

19. The one or more non-transitory computer-readable media of claim 18, wherein enabling access to maintenance ports of the chip comprises:
enabling access to maintenance ports of the chip for debugging of a next stage boot image located on the non-volatile memory.

20. The one or more non-transitory computer-readable media of claim 19, wherein authenticating, by the boot image, the secure maintenance image comprises:
authenticating an exclusive chip ID (ECID) of the chip;
authenticating a hash of a loader; and
authenticating debug lifecycles within the secure maintenance image.
